(19) United States
(12) Patent Application Publication
(10) Pub. No.: US 2015/0325349 A1
(43) Pub. Date: Nov. 12, 2015

(54) HIGH PERFORMANCE PERMANENT MAGNET BASED ON MnBi AND METHOD TO MANUFACTURE SUCH A MAGNET

(71) Applicant: SIEMENS AKTIENGESELLSCHAFT, Munchen (DE)

(72) Inventors: Alexander GABAY, Newark, NJ (US); George HADJIPANAYIS, Wilmington, DE (US); Michael KRISPIN, Munich (DE); Venkata Ramarao NEELAM, Hyderabad (IN)

(73) Assignee: SIEMENS AKTIENGESELLSCHAFT, Munchen (DE)

(21) Appl. No.: 14/272,079

(22) Filed: May 7, 2014

(51) Int. Cl. H01F 1/047; H01F 1/08; B22F 9/04; H01F 41/02; B22F 3/02; B22F 3/24

(52) U.S. Cl. CPC H01F 1/047; B22F 3/02; B22F 3/24; B22F 9/04; H01F 41/0266; H01F 1/08; B22F 2003/248; B22F 2009/043

(57) ABSTRACT

The invention refers to a method for manufacturing a at least 90% relative density of MnBi comprising permanent magnet (7), with a step of synthesizing (ST1a) an anisotropic low temperature phase (LTP) MnBi powder consisting of crystallite particles (1), whereby an aligned and pre-compacted powder is annealed below 628K such that a liquid Bi film (5) is formed around each of the MnBi particles (1).

The invention refers to method for manufacturing of a permanent magnet based on MnBi and to a corresponding MnBi permanent magnet.

Many applications as motors and generators require high performance permanent magnets. Sufficient magnetic properties are reached today only by anisotropic sintered magnets based on the composition REE-Fe-B, where REE is a Rare Earth Element. These include light rare earth elements (LREE) as Nd or Pr as well as heavy rare earth elements (HREE), e. g. Dy and Tb. Rare earth elements, especially heavy rare earth elements are critical materials in terms of their limited amount and available mining sites. Today's demand on permanent magnet based motors and generators are rapidly increasing as these are needed for e.g. e-mobility and green energy generation. Due to the supply risks and high prices of rare earth elements new solutions for high performance magnets suitable for application in motors and generators are needed.

The performance of a permanent magnet is expressed by its coercivity (Hc) and remanence (Br) which both contribute to the specific stored magnetic energy. This energy is traditionally expressed via the maximum energy product (BH)max—a figure of merit of permanent magnets—which is the largest for anisotropic sintered REE-based magnets. The function of REE is to introduce large crystal anisotropy which leads to large magnetic anisotropy and therefore a large coercivity. Coercivity in LREE-Fe-B magnets decreases with increasing temperature which limits the application range to temperatures below 100° C. To compensate this effect, HREE are added which allow to increase the temperature range to about 220° C. However, the addition of high amount of HREE (up to 15-20%) increases the material cost even more. For so called nucleation hardened magnets, where the coercivity relies on suppressing the formation/nucleation of reverse domains, the coercivity not only relies on the composition but also on the microstructure. It is increased with decreasing the crystallite size which is accompanied by decreasing of the number of nucleation sites in individual crystallites.

A Material with the potential for high coercivity is the low temperature phase (LTP) of MnBi with its high intrinsic magnetic anisotropy field. In analogy to REE magnets the high anisotropy field makes it a good candidate to build high performance magnets (see e.g. U.S. Pat. No. 2,576,679). In addition, the positive temperature coefficient of the coercivity of MnBi is of advantage for high temperature applications. Although the material is known for a long time and raw material cost is low compared to REE based magnets, MnBi magnets are currently not commercially available. This is because of several challenges that need to be solved. To achieve a high energy product the magnet must consist of nearly 100% LTP MnBi and its crystallites must have all their [001] crystallographic directions (the easy magnetization directions) to be parallel to the intended direction of the magnetization. The default method for manufacturing high-(BH)max permanent magnets consists of milling the base material into a fine single crystal powder, alignment of the powder with a magnetic field and sintering it into a fully-dense body. In the case of MnBi, this process has been a technical challenge only recently solved by combining low energy ball milling of a MnBi ingot with vacuum hot pressing in vacuum (see [1]).

[1] discloses manufacturing of a almost fully dense MnBi permanent magnet with a high energy product and high coercivity at elevated temperatures. The achieved magnetic properties are: Coercivity Hc of 6.5 kOe up to 28.3 kOe depending on temperature 300K up to 530K. Remanence Bᵣ about 45.0 emu g⁻¹ or Bᵣ=5 kG. Saturation Magnetization Mₛ about 50 emu g⁻¹. Remanence ratio Bᵣ/Mₛ of about 0.90. Maximum Energy Product (BH)max of 3.6 MG Oe at 530K and about 5.8 MG Oe at room temperature. Relative density is about 98%.

At present MnBi magnets are not commercialized. Recently a permanent magnet with an energy product exceeding 5.8 MGOe by hot compaction of anisotropic LTP MnBi powder in vacuum was reported. The MnBi powder was prepared via low energy ball milling (see [1]). Also bonded MnBi magnets are reported in literature. The disadvantage of this method is the reduction of the magnetization by the dilution of the magnetic material by the addition of non magnetic resin.

It is an object of the invention to provide a method for manufacture of a permanent magnet based on MnBi and to provide a corresponding MnBi magnet. In particular anisotropic sintered magnets based on the composition Rare Earth Element-Fe-B should be replaced. The usage of Rare Earth Elements should be avoided. The permanent magnet should be a fully or an almost fully dense magnet. It should comprise an increased coercivity H_{c} and an increased remanence Bᵣ in comparison to other MnBi state of the art permanent magnets, e.g. as disclosed by [1]. Losses of magnetic properties of Low Temperature Phase MnBi after a compaction to the permanent magnet should be minimized. The permanent magnet should be of advantage for applications at temperatures up to about 600 K. Moreover the production costs should be low.

A fully or an almost fully dense permanent magnet comprises a real density relative to a theoretical density of a pure permanent magnet, whereby this relative density is at least 90%. For MnBi a theoretical density is 8.99 g cm⁻³. The difference between real and theoretical density can be caused by residual of additives, Manganese and Bismuth segregations, and/or by porosities. The inventive permanent magnet comprises at least 90% relative density of MnBi, with respect to an originally used amount of an anisotropic low temperature phase (LTP) MnBi powder.

A density of a complete magnet in relation to the theoretical density of MnBi is meant to be for the case that ferromagnetic material particles are not added. In the case of adding the ferromagnetic material particles the theoretical density changes and results from the sum of the used volumes divided by the overall mass.

A Low Temperature Phase (LTP) MnBi powder is defined as a powder consisting of MnBi particles. The chemical formula for High temperature Phase (HTP) is Mn_{1.08}Bi. MnBi and Mn_{1.08}Bi are separate compounds. A stoichiometric MnBi compound can be formed by the peritectic reaction of Mn+Bi-rich liquid solution at 719 K. Furthermore, the compound undergoes a magnetic and structural transformation at about 628 K upon heating and at about 613 K upon cooling. The ferro-to-paramagnetic transition upon heating to 628 K corresponds to the phase decomposition of LTP to HTP+Bi. The para-to-ferromagnetic transition upon cooling to 613 K corresponds to the phase decomposition of HTP to LTP+Mn. Reference is also made to FIG. 9 showing an equilibrium phase diagram of the Mn—Bi system.

Magnetic Polarization J is an addition in magnetic induction AB caused by bringing a substance into a magnetic field H, whereby the magnetic field H remains unchanged.

Magnetic Saturation Polarization Jₛ is a maximum value of the Magnetic Polarization J in a hysteresis loop of a ferromagnetic material. In other words the Magnetization does not further increase with increase of the external magnetic field H.

Compaction is usually performed by filling a magnetic powder into a mold (ST2), then by magnetically aligning (ST3), then by pre-compacting under pressure (ST4) and finally annealing (ST5) optionally under pressure. ST is here an abbreviation for “STAGE” with reference to the further application text.

The object is solved by a method according to the main claim and a correspondingly manufactured MnBi permanent magnet according to the first accessory claim and an application according to the second accessory claim.

This invention addresses the challenge of preparation of a nearly fully dense magnet with larger than 90% theoretical density based on MnBi with high coercivity and remanence. The challenge is minimizing losses of the magnetic properties of LTP MnBi powder after compaction to a fully dense magnet. Already at a temperature of 355° C. the LTP MnBi decomposes into Mn_{1.08}Bi and liquid Bi (see [2]).

Therefore, the classical sinter processes cannot be applied. Moreover, the LPT MnBi is also sensitive to external pressure resulting in a significant decrease of the magnetic properties. This excludes other pressure forming techniques like backward extrusion which are common to induce crystallographic anisotropies in REE isotropic nano scale powders.

A second challenge is the improvement of the remanence of MnBi magnet. The intrinsic spontaneous magnetization of MnBi is rather low in comparison to REE based magnets and is further decreased if parts of LTP MnBi are decomposed during powder synthesis and subsequent compaction. Therefore a novel process was invented to increase the magnetization of MnBi based magnets.

MnBi particles significantly smaller than 1 μm have the advantage of higher coercivity and, unlike the larger particles, they are suitable for manufacturing of nanocomposite magnets in which the MnBi phase is coupled via magnetic exchange interaction with a high-magnetization phase. However, the practical limit of the MnBi particle size reduction via milling is 3-5 μm. Although particle size reduction down to slightly smaller than 1 μm is possible in principle—via a significant extension of the milling time,—such reduction is accompanied by a significant decrease of the remanence.

This deterioration of the remanence with an extensive milling is caused by emergence of subgrains inside the MnBi particles as well as by progressive decomposition of the LTP MnBi compound.

This invention addresses these challenges and gives a solution for it.

According to a first aspect a method for manufacturing are at least 90% relative density of MnBi comprising permanent magnet is claimed, with synthesizing an anisotropic low temperature phase (LTP) MnBi powder, suitable for the preparation of an anisotropic permanent magnet, consisting of crystallite particles; whereby the powder is filled into a mould, then magnetically aligned and pre-compacted under pressure, whereby the aligned and pre-compacted powder is annealed below the MnBi the composition temperature of 628K such that a liquid Bi film is formed around each of the MnBi particles, and afterwards a cooling down is performed for solidifying the liquid Bi film and for bonding the MnBi particles.

The invention addresses the use of anisotropic LTP MnBi particles and processing of these particles to obtain a high performance permanent magnet suitable to replace partly expensive REE based permanent magnets. Therefore a compaction technique is invented which leads to a fully dense magnet with minimum of LTP MnBi decomposition and therefore mainly preserves the properties of the original LTP MnBi particles. The liquid Bi phase obtained during compaction is used as a matrix to bond LTP MnBi particles which result in a high fraction of LTP MnBi with highest possible remanence due to the abandonment of additional resins. Also the thin Bi-Film suppresses the magnetic exchange coupling between different single domain MnBi particles which is advantageous to obtain a large coercivity. Advantageously REE-free high performance magnet for possible application in motors and generators can be formed by lower material cost in comparison to REE based magnets whereby near net shape production of MnBi magnet is possible. Moreover, due to the positive temperature coefficient of MnBi coercivity of the magnet increases such that higher temperature applications are possible.

According to a second aspect a high performance permanent magnet comprising at least 90% relative density of MnBi on base of an anisotropic low temperature phase (LTP) MnBi powder consisting of crystallite particles can easily be manufactured according to the inventive methods.

It was discovered that a classical sinter process cannot be applied because of temperature sensitivity of LTP MnBi. Because of sensitivity to external pressure of LTP MnBi classical pressure forming techniques like backward extrusion also cannot be applied.

Further advantages embodiments are claimed by the subclaims.

According to an embodiment after the synthesizing and e.g. before the anisotropic low temperature phase (LTP) MnBi powder is filled into the mould the MnBi powder can be mixed with an additional powder of ferromagnetic material particles with a high magnetic saturation polarization, in particular of more than 1 T or more than 1.5 T. It is of advantage to mix anisotropic LTP MnBi nano scale particles with particles of high spontaneous magnetization in a way they magnetically exchange couple which results in an increase of rermanence. Advantageously also a near net shape production of MnBi composite magnets is possible.

According to another embodiment a mean size of the ferromagnetic material particles can be in a range of 5 nm to 50 nm and are smaller than LTP MnBi particles.

According to another advantageous embodiment the ferromagnetic material particles can comprise at least one of the elements Fe and Co, in particular comprise a-iron, cobalt, FeCo alloy or Fe₁₆N₂.

According to another advantageous embodiment a mean size of the MnBi crystallite particles can be equal to or smaller than a single domain size of MnBi of about 1 μm, in particular smaller than 500 nm or smaller than 100 nm or smaller than 50 nm.

According to another advantageous embodiment for the synthesizing of the MnBi crystallite particles manganese or manganese metal and bismuth oxide or manganese oxide and bismuth metal can be mixed with calcium metal and are then mechanically activated through a high-energy ball milling in an oxygen-free atmosphere.

According to another advantageous embodiment before high-energy ball milling a calcium oxide dispersant powder can be added.

According to another advantageous embodiment after the high-energy ball milling a first annealing at 700° C. to 1000° C. can be performed for completing a reduction of the oxide(s) and for forming a Mn—Bi alloy.

According to another advantageous embodiment after the first annealing at 700° C. to 1000° C. a second annealing at 260° C. (533K) to 350° C. (623K) can be performed for converting the Mn—Bi alloy into low temperature phase (LTP) MnBi powder consisting of particles.

According to another advantageous embodiment a separating of aggregates of the low temperature phase (LTP) MnBi particles from the calcium oxide and/or other calcium phases by ultrasound-assisted leaching with water can be performed.

According to another advantageous embodiment the aggregates of the low temperature phase (LTP) MnBi particles can be dispersed through high-intensity ultrasound irradiation while being suspended in organic solvents and/or silicone oil.

According to another advantageous embodiment the anisotropic low temperature phase (LTP) MnBi powder can be thoroughly mixed with the additional powder of ferromagnetic material particles at a ration such that the ferromagnetic material particles do not touch each other or a lateral touching area of two touching ferromagnetic material particles is respectively less than 50 nm to prevent exchange coupling among the ferromagnetic material particles.

According to another advantageous embodiment the aligned powder can be pre-compacted with a pressure below 400 MPa in particular in a range of 200 MPa to 400 MPa.

According to another advantageous embodiment the annealing of the aligned and pre-compacted powder can be performed above 260° C. (533K) and below 355° C. (628K) temperature.

According to another advantageous embodiment the annealing of the aligned and pre-compacted powder can be performed under vacuum or in an inert atmosphere.

According to another advantageous embodiment the annealing of the aligned pre-compacted powder can be performed in a furnace or in a microwave heater.

According to another advantageous embodiment the annealing of the aligned and pre-compacted powder can be performed under a compaction pressure in particular below 500 KPa.

According to another advantageous embodiment the alignment, the pre-compaction and annealing can be performed such that a magnetic exchange coupling between the MnBi particles and the ferromagnetic material particles is supported.

According to another advantageous embodiment a high performance magnet according to the invention can be used for an electrical motor or an electrical generator.

The invention will be described more precisely with reference to embodiments and the figures. The figures show:

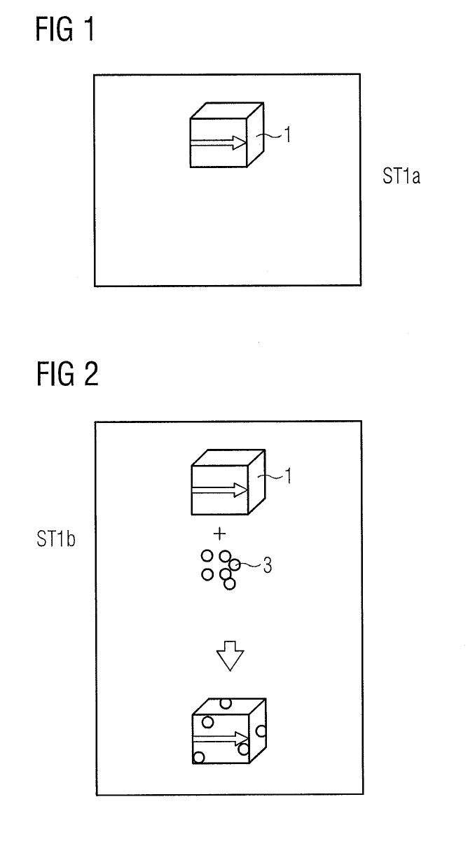

FIG. 1 a first embodiment of an inventive starting unit;

FIG. 2 a second embodiment of an inventive starting unit;

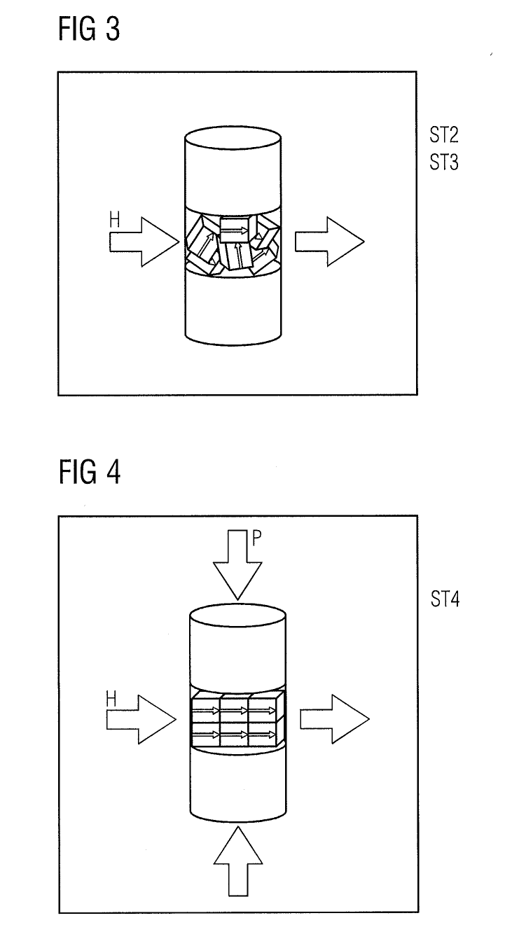

FIG. 3-5 an embodiment of an inventive compacting procedure;

FIG. 6 a first embodiment of an inventive particle and inventive MnBi magnet;

FIG. 7 shows a second embodiment of an inventive particle and inventive composit magnet;

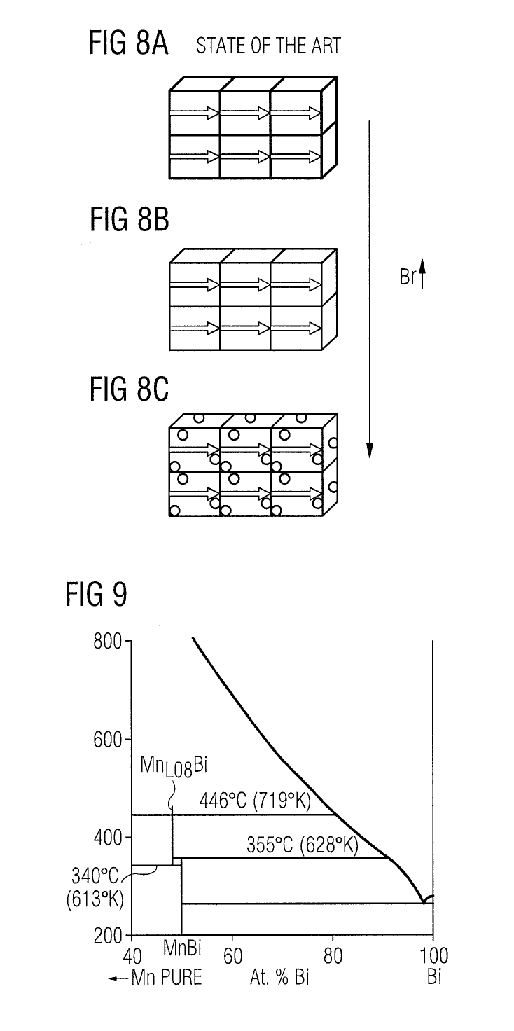

FIGS. 8A-8C show three embodiments of magnets;

FIG. 9 shows a equilibrium phase diagram of the MnBi system;

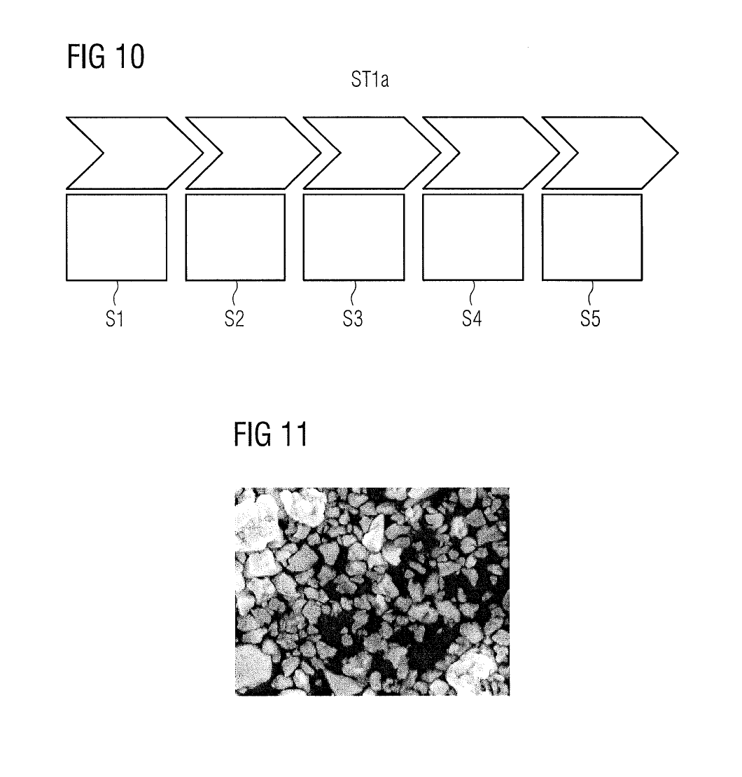

FIG. 10 shows an embodiment of an inventive powder synthesizing;

FIG. 11 shows a scanning electron microscope (SEM) micrograph;

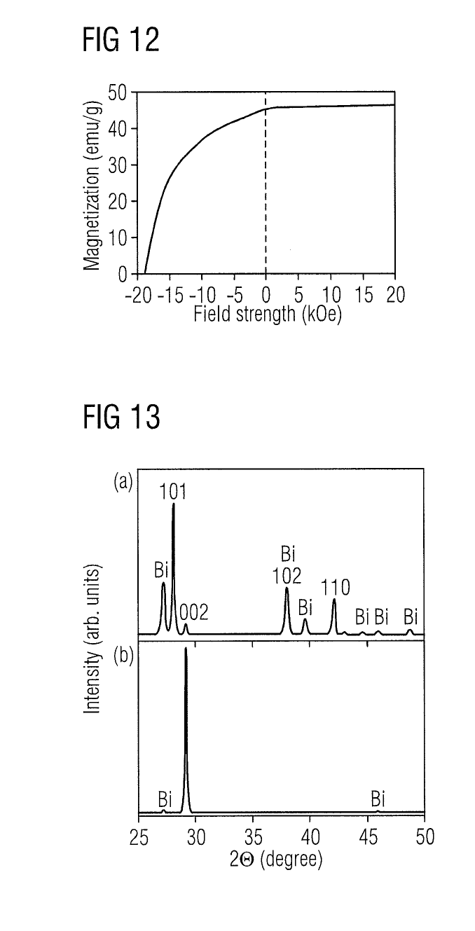

FIG. 12 shows a demagnetization curve;

FIG. 13 shows x-ray diffraction (XRD) patterns.

FIG. 1 shows a first embodiment of an inventive starting unit. FIG. 1 shows an anisotropic low temperature phase (LTP) crystallite particle 1. This embodiment addresses a process which leads to nearly fully dense MnBi magnet with high LTP MnBi content which nearly retains the magnetic properties of a powder of these crystallite particles 1. The synthesizing of these crystallite particles 1 is described by reference to FIG. 10. FIG. 1 shows an anisotropic MnBi particle 1, whereby the arrow indicates magnetic anisotropy.

FIG. 2 shows a second embodiment of an inventive starting unit. According to FIG. 2 a crystallite particle 1 of FIG. 1 is mixed with an additional powder of ferromagnetic material particles 3 with a high magnetic saturation polarization, in particular of more than 1 T or more than 1.5 T. Numeral 3 indicates the high magnetic saturation polarization particles 3. The result of the mixing is an anisotropic MnBi particle 1 with high magnetic saturation polarization nano particles 3. To sum up to further increase the magnetization the LTP MnBi powder is mixed with a second powder having high spontaneous magnetization.

FIGS. 3 to 5 show an embodiment of an inventive compacting procedure. At the beginning an anisotropic MnBi powder with a large content of LTP more than 70%, better more than 90%, and with a large coercivity is used. Ideally the mean crystallite size can be adjusted to the single domain size of MnBi. The preparation of the particles 1 can be done but is not limited to low energy ball milling, cryomilling or mechanochemical synthesis. According to FIG. 3 the particles 1 are filled into a mold and are magnetically aligned, e.g. by an external magnetic field H that can be perpendicular to the pressing direction. FIG. 4 shows a pre-compaction with a limited pressure below 400 MPa, preferable in the range 200-400 MPa.

FIG. 3 shows the stage ST2 of filling the powder into a mold and stage ST3 being the magnetical alignment.

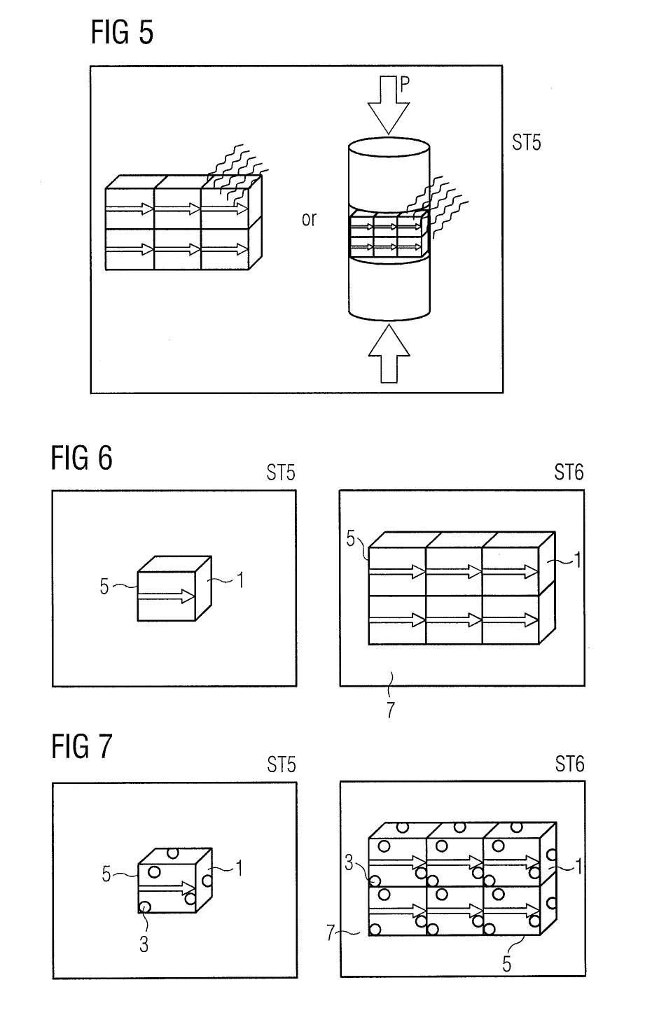

FIG. 4 shows the stage ST4 which is the pre-compaction under a pressure. FIG. 5 shows the annealing stage ST5. Without further pressure or only slight pressure the aligned and pre-compacted powder is annealed, in particular close to the decomposition temperature above 260° C. and below 355° C. in a way that a thin liquid Bi-film is formed around the MnBi particles or the MnBi particles with the ferromagnetic particles 3. This ensures that only a minimum volume of the LTP MnBi is decomposed. The annealing of stage ST5 can be performed under vacuum or in inert atmosphere, e.g. in a conventional furnace or via microwave irradiation. Afterwards a cooling down at a stage ST6 the liquid Bi film solidifies and bonds the MnBi particles 1 and optionally with the ferromagnetic particles 3 to a fully dense magnet which is shown in FIGS. 6 and 7.

FIG. 6 shows a first embodiment of an anisotropic MnBi particle 1 which is covered by a thin Bi layer 5. This is the condition after the annealing stage ST5. On the right side of FIG. 6 an embodiment of an inventive magnet composed of building blocks is shown, whereby a MnBi magnet 7 with a high LTP MnBi content is shown. The right side of FIG. 6 shows the result of the cooling stage ST6.

FIG. 7 shows the stage ST5 after the annealing heat treatment on base of the second embodiment of an inventive starting unit according to FIG. 2. On the left side of FIG. 7 an anisotropic MnBi particle 1 with high saturation polarization nano particles 3 covered by a thin Bi layer or film 5. FIG. 7 on the right side shows the result of the compaction, whereby a MnBi composite magnet 7 with a high magnetization was composed out of building blocks.

FIG. 7 represents the idea of increasing the magnetization of the MnBi magnet 7 by introducing a second phase 3 with high magnetization and mixing the second phase with the LTP MnBi particles 1. The size of the MnBi particles 1 in the composite magnets 7 is limited to 500 nm, better smaller than 100 nm, best smaller than 50 nm, while the particle size of the second phase particles 3 is in the range of 5 nm to 50 nm. The smaller the size of the MnBi particles 1, the greater volume fraction of the high-magnetization phase can be introduced by maintaining the interphase magnetic coupling. The second phase contains at least one of the elements Fe or Co.

Examples for possible materials as a second phase are a-iron, cobalt, FeCo alloy or Fe₁₆N₂.

FIG. 8 shows embodiments of resulting permanent magnets composed of building blocks. FIG. 8A shows a state of the art MnBi magnet with a medium LTP MnBi content. FIG. 8B shows the MnBi magnet with high LTP MnBi content according to FIG. 6, which bases on the starting unit of FIG. 1.

FIG. 8C shows a MnBi composite magnet with high magnetization basing on the results of FIG. 7 and on the starting units according to FIG. 2. With reference to FIG. 8C the volume fraction of LTP MnBi powder is larger than 50%, most preferably 70% to 90%. The ratio of the particles 1 and particles 3 can be adjusted to obtain a magnet with specific magnetic properties. The particles need to be thoroughly mixed in a way that the particles 3 of the second phase do not touch or the lateral dimension of the touching second phase is less than 50 nm, respectively. This separation of the second phase of the ferromagnetic material particles 3 must maintain during the process of compaction. Also the interdiffusion between the MnBi particles 1 and the second phase particles 3 must be inhibited during compaction. The compaction itself can be performed similar to the above described process under vacuum or inert atmosphere to prevent oxidation of the particles. After compaction the array of MnBi particles 1 and second phase particles 3 is such that magnetic exchange coupling is supported.

FIG. 8B shows the advantageous embodiment of the anisotropic MnBi particles 1 with high LTP content which are oriented and compacted in a way that the magnetic properties are restored and a fully dense magnet is formed. The compaction process is optimized that each MnBi particle 1 is wetted by a thin liquid Bi layer or film 5 that acts as a binder between particles 1. The magnet exhibits magnetic properties superior to earlier MnBi magnets. Its coercivity is comparable to REE-based magnets and the remanence is significantly higher than ferrite based permanent magnets.

FIG. 8C shows the second advantageous embodiment, whereby the anisotropic MnBi particles 1 with high LTP content are mixed with soft magnetic nano particles 3 with high spontaneous magnetization. The ratio of MnBi particles 1 to soft magnetic nano particles 3 is chosen in a way that after mixing the soft magnetic nano particles 3 are separated to prevent exchanging coupling amongst them. The mixture is then oriented and compacted in a way that two magnetic phases 1 and 3 are exchange coupled and a fully dense magnet 7 is formed. Resulting in a further increase of the remanence. Starting with FIG. 8A to FIG. 8C the resulting remanence Bᵣ is increased. FIG. 8A to 8C show MnBi based bulk magnets 7.

FIG. 9 shows a equilibrium phase diagram of the MnBi system, in particular showing the critical temperatures for avoiding decompositions of MnBi. This relevant MnBi decomposition temperature is around 628K.

FIG. 10 shows an embodiment of an inventive procedure for synthesizing an anisotropic low temperature phase (LTP) MnBi powder according to a firsts stage ST1a. The MnBi particles 1 having the size of 500 nm or smaller are to prepared via a 5-step S1 to S5 mechanochemical process. In the first step S1, a mixture of manganese and bismuth oxides (or manganese metal and bismuth oxide or manganese oxide and bismuth metal) with calcium metal and with an optional addition of a CaO dispersant powder is subjected to a mechanical activation through a high-energy ball milling in oxygen-free atmosphere. In the second step S2, the mixture annealed at 700° C. to 1000° C. in order to complete the reduction of the oxide(s) and to form a particulate Mn—Bi alloy. In the third step S3, the mixture is annealed at 260° C. to 350° C. to convert the Mn—Bi alloy into the LTP MnBi phase. In the fourth step S4, aggregates of the LTP MnBi particles are separated from the CaO and other phases by ultrasound-assisted leaching with water. In the fifth step S5, the aggregates of the LTP MnBi particles 1 are dispersed through high-intensity ultrasound irradiation while suspended in organic solvents and/or silicone oil. The resulting crystallographically anisotropic particles 1 contain more than 70 vol. % of the LTP MnBi phase.

To sum up at a step S1 a high energy milling is performed for mixing of manganese, bismuth oxide, calcium metal and calcium oxide. At the second step of a first annealing the formation of Mn—Bi alloy at 700° C. to 1000° C. is performed. At a third step S3 of a second annealing a conversion into LTP MnBi is performed at temperatures between 260° C. to 350° C. A fourth step S4 is the separation of aggregates of LTP MnBi from other phases by ultrasound assisted leaching. The last and fifth step S5 concerns the dispersion of LTP MnBi aggregates by high intensity ultrasound irradiation.

FIG. 10 shows the schematic of mechanochemical processes for synthesis of anisotropic LTP MnBi particles according to a stage ST1a.

FIG. 11 shows a scanning electron micrograph of mechanochemically synthesized MnBi powder consisting of crystallite particles 1.

FIG. 12 shows demagnetization graphs of field-oriented mechanochemically synthesized MnBi powder.

FIG. 13 shows XRD spectra of (a) randomly oriented and (b) field-oriented mechanochemically synthesized MnBi powder. In particular, the large peak in (b) shows that the crystallites of the principal LTP MnBi phase, which is marked with Miller indexes, exhibit very high degree of anisotropy.
[1]: J. Phys. D: Appl. Phys. 46 062001 (2013);
[2]: IEEE Trans Mag 10 581 (1974)

1. Method for manufacturing a permanent magnet with at least 90% relative density of MnBi, with respect to an originally used amount of an anisotropic low temperature phase MnBi powder, with a first step of synthesizing the anisotropic low temperature phase MnBi powder consisting of crystallite particles; whereby
the powder is filled into a mold, magnetically aligned and pre-compacted under pressure;
characterized in that
the aligned and pre-compacted powder is annealed below the MnBi decomposition temperature of 628 K such that a liquid Bi film is formed around each of the MnBi particles, and afterwards a cooling down is performed for solidifying the liquid Bi film and for bonding the MnBi particles.

2. Method according to claim 1,
characterized in that
after the synthesizing of the anisotropic low temperature phase MnBi powder it is mixed with an additional powder of ferromagnetic material particles with a high magnetic saturation polarization, in particular of more than 1 T or more than 1.5 T.

3. Method according to claim 2,
characterized in that
a mean size of the ferromagnetic material particles is in a range of 5 nm to 50 nm and smaller than MnBi particles.

4. Method according to claim 3,
characterized in that
the ferromagnetic material particles comprise at least one of the elements Fe and Co, in particular comprise a-iron, cobalt, FeCo alloy or Fe16N2.

5. Method according to claim 4,
characterized in that
a mean size of the MnBi crystallite particles is equal to or smaller than a single domain size of MnBi of about 1 μm, in particular smaller than 500 nm or smaller than 100 nm or smaller than 50 nm.

6. Method according to claim 5,
characterized in that
for the synthesizing of the MnBi crystallite particles manganese or manganese metal and bismuth oxide or manganese oxide and bismuth metal are mixed with calcium metal and are then mechanically activated through a high-energy ball milling in an oxygen-free atmosphere.

7. Method according to claim 6,
characterized in that
before high-energy ball milling a CaO dispersant powder is added.

8. Method according to claim 7,
characterized in that
after the high-energy ball milling a first annealing at 700° C. to 1000° C. is performed for completing a reduction of the oxide(s) and for forming a Mn—Bi alloy.

9. Method according to claim 8,
characterized in that
after the first annealing at 700° C. to 1000° C. a second annealing at 260° C. (533 K) to 350° C. (623 K) is performed for converting the Mn—Bi alloy into low temperature phase MnBi powder consisting of particles.

10. Method according to claim 9,
characterized by
separating aggregates of the low temperature phase MnBi particles from the CaO and/or other Ca phases by ultrasound-assisted leaching with water.

11. Method according to claim 10,
characterized in that
the aggregates of the low temperature phase MnBi particles are dispersed through high-intensity ultrasound irradiation while being suspended in organic solvents and/or silicone oil.

12. Method according to one of the precedent claim 11,
characterized in that
the anisotropic low temperature phase MnBi powder is thoroughly mixed with the additional powder of ferromagnetic material particles at a ratio such that the ferromagnetic material particles do not touch each other or a lateral touching area of two touching ferromagnetic material particles is respectively less than 50 nm to prevent exchange coupling among the ferromagnetic material particles.

13. Method according to claim 12,
characterized in that
the aligned powder is pre-compacted with a pressure below 400 MPa, in particular in a range of 200 MPa to 400 MPa.

14. Method according to claim 13,
characterized in that
the annealing of the aligned and pre-compacted powder is performed above 260° C. (533 K) and below 355° C. (628 K) temperature.

15. Method according to claim 14,
characterized in that
the annealing of the aligned and pre-compacted powder is performed under vacuum or in an inert atmosphere.

16. Method according to claim 15,
characterized in that
the annealing of the aligned and pre-compacted powder is performed in a furnace or in a microwave heater.

17. Method according to claim 16,
characterized in that
the annealing of the aligned and pre-compacted powder is performed under a compaction pressure, in particular below 500 KPa.

18. Method according to claim 17,
characterized in that
the alignment, the pre-compaction and the annealing are performed such that a magnetic exchange coupling between the MnBi particles and the ferromagnetic material particles is supported.

19. High performance permanent magnet comprising at least 90% relative density of MnBi, on base of an anisotropic low temperature phase MnBi powder consisting of crystallite particles, characterized in that the permanent magnet is manufactured by a method according to one of the precedent claims.

20. Application of a high performance permanent magnet according to claim 19 for an electrical motor or an electrical generator.
